(19) United States
(12) Patent Application Publication
(10) Pub. No.: US 2011/0290589 A1
(43) Pub. Date: Dec. 1, 2011

(54) Consumable Applicator

(75) Inventors: Kevin Oldknow, North Vancouver (CA); David Elvidge, North Vancouver (CA); Donald Eadie, Vancouver (CA); Xin Lu, Vancouver (CA); Jonathan De Wet, North Vancouver (CA)

(73) Assignee: KELSAN TECHNOLOGIES CORP, North Vancouver, BC (CA)

(21) Appl. No.: 13/128,281

(22) PCT Filed: Nov. 10, 2009
(86) PCT No.: PCT/CA2009/001632

§ 371 Date: Aug. 3, 2011

Related U.S. Application Data
(60) Provisional application No. 61/113,049, filed on Nov. 10, 2008.

(51) Int. Cl. F16N 11/04; B05D 5/08; F16N 31/00; F16N 7/00; F16N 15/00; F16N 19/00

(52) U.S. Cl. 184/45.2; 427/427.4

(57) ABSTRACT

A consumable applicator comprising one or more conduits in a fluid communication with a liquid composition dispensing system wherein the liquid composition comprises friction control components. The consumable applicator comprises a solid body having hardness of less than or equal 150 HB, a housing and a biasing member within said housing for advancing the consumable applicator toward a dispensing end. The consumable applicator may be used for applying a friction control consumable to sliding metallic parts such as the railway rails or wheels.

### FIELD OF INVENTION

The present invention relates to a consumable applicator and methods for using the consumable applicator. The present invention also relates to a consumable applicator comprising friction control compositions and methods for using the consumable applicator.

### BACKGROUND OF THE INVENTION

Steel-rail and steel-wheel transportation systems including freight, passenger and mass transit rail systems suffer from the emission of high noise levels and extensive wear of mechanical components such as wheels, rails and other rail components such as ties. The origin of such noise emission, and the wear of mechanical components may be directly attributed to the frictional forces and behaviour that are generated between the wheel and the rail during operation of the system. The application of solid or liquid friction modifier compositions, to railroad tracks, wheel, or both, can significantly reduce the wear on both the railcar wheels and on the rails. Liquid friction modifier compositions are known in the art, see for example U.S. Pat. No. 7,045,489, U.S. Pat. No. 6,855,673, U.S. Pat. No. 6,759,372, U.S. Pat. No. 6,136,757, U.S. (which are incorporated herein by reference), as are solid friction modifier compositions, see for example U.S. Pat. No. 5,173,204, U.S. Pat. No. 5,308,516, EP 474,750, WO 2006/084386 (which are incorporated herein by reference), and applicator systems, see for example WO 2006/000093, U.S. Pat. No. 6,854,908, WO 2006/116877 (which are incorporated herein by reference).

With systems that use liquid friction modifiers, it is desired to meter the amount of the liquid composition applied in a controlled manner. Uncontrolled application may result in an excess amount of liquid composition being applied to the rails or the flanges of the rail car wheels leading to wastage. Furthermore, if the liquid composition is a lubricant composition, excess application may result some of the lubricant to coat the tread portion of the rail car wheels. The lubricant on the tread portion of the wheels can then coat the top of the rail and result in appreciable slippage of the rail car wheels on the rail. In addition, if the liquid lubricant is applied at too high a flow rate it may be flung from the wheel to beneath the rail car, and result in contamination of the environment.

In attempting to overcome the above problems experienced with liquid lubrication systems, solid lubricant or friction modifier compositions in the form of sticks have been used to apply compositions to the flanges of rail car wheels. Solid lubricants may have advantages over liquid lubricants in the area of reduced attraction/retention of dirt, reduced contamination of adjoining unlubricated surfaces and acting as a protective covering (e.g., corrosion protection). However, railroads have maintenance cycles that last longer than the life of a solid composition. Friction management using only solid sticks may require a closed system to achieve adequate buildup of the friction control product on the rail. Freight systems are typically open with widespread interchange of cars. In such a system, solid stick technology is less practical.

The friction is greatest on curves, and lubrication is thus most effective when applied to curved areas of the track. In the past, the conventional practice has been to use stationary wayside lubricating devices for the application of lubricant. The wayside lubricator pumps grease onto the flange of the rail at a selected location and relies on the wheels of the train to spread the grease along the entire curved area of the track. As can easily be appreciated, a large part of the grease is essentially wasted because it is thrown off of the rail by the wheels, or leaks from the bars at the point of application. In addition much lubricant ends up being applied in tangent track instead of curves where the predominant rail wear occurs, further increasing the inefficiency. Consequently, the lubricant is applied in an uneconomical manner by the way side lubricators. A very large number of lubricators are required along a given stretch of track since the lubricant will only carry for a few miles from the point of application.

Due in large part to these shortcomings associated with wayside lubricators, mobile lubricating systems have been used. Lubricants and friction modifiers can be applied in both solid stick and liquid form, however the transfer rate or retentivity of solid stick lubricants and friction modifiers is not typically sufficient to achieve the desired benefits in ‘open’ systems (e.g. North American heavy haul freight). As such, liquid products such as oils and water-based friction modifiers are more typically applied from spray-based mobile systems in open (and some closed) systems.

In order to implement spray-based mobile systems system reliability is required, including spray accuracy, and reduced nozzle plugging and fouling. Furthermore, cross-winds affect spray-based application systems. In the case of flange lubricants, spray accuracy and reliability issues can also lead to undesirably low friction levels on the top-of-rail surface.

### SUMMARY OF THE INVENTION

The present invention relates to a consumable applicator and methods for using the consumable applicator. The present invention also relates to a consumable applicator comprising friction control compositions and methods for using the consumable applicator.

It is an object of the invention to provide an improved consumable applicator.

The present invention provides a consumable applicator comprising a first and a second end, one or more than one conduit within the consumable applicator exiting the first end, the second end for fitting with a housing.

The consumable applicator as described above may further be characterized as having a hardness of less than 150 BH. The consumable applicator may be comprised of a friction control composition, the friction control composition comprising from about 20 to about 100 weight percent resin; from 0 to about 80 weight percent lubricant; from 0 to about 40 weight percent friction modifier, and from about 0 to about 30 weight percent plasticizer.

The one or more than one conduit within the consumable applicator may be in fluid communication with a liquid dispensing system. The one or more than one conduit may be a tube within the consumable applicator, or an opening formed with in the body of the consumable applicator.

The friction control composition may be selected from the group characterized as having a neutral friction characteristic (LCF), a high positive friction characteristic (HPF), and a very high positive friction characteristic (VHPF).

The present invention also relates to a housing for receiving the consumable applicator defined above, the housing comprises a dispensing end and a second end, a biasing element for advancing the consumable applicator from the second end to the dispensing end, and a second conduit in fluid communication with the liquid dispensing system and the one or more conduit within the consumable applicator.

The present invention further relates to a method of controlling friction between two or more than two metal surfaces in sliding rolling contact comprising applying a liquid friction control composition, or a liquid and solid friction control composition to one of the two or more than two metal surfaces using a consumable applicator, the consumable applicator comprising a first and a second end and a conduit within, the conduit exiting the first end, the second end for fitting with a housing.

The solid friction control composition of consumable applicator of the method as described above may comprise from about 20 to about 100 weight percent resin; from 0 to about 80 weight percent lubricant; from 0 to about 40 weight percent friction modifier, and from about 0 to about 30 weight percent plasticizer, the liquid friction control composition comprising from about 40 to about 95 percent water; from about 0.5 to about 50 percent rheological agent; from about 0.5 to about 40 percent retentivity agent; from about 0 to about 40 weight percent lubricant; and from about 0 to about 25 weight percent friction modifier, whereby application of the liquid friction control composition, or the liquid and solid friction control composition controls friction between the two or more than two surfaces. The conduit within the consumable applicator may be in fluid communication with a liquid dispensing system. The liquid friction control composition, or the solid friction control composition may be selected from the group characterized as having a neutral friction characteristic (LCF), a high positive friction characteristic (HPF), and a very high positive friction characteristic (VHPF).

The present invention also is directed to a method of reducing lateral forces, and wheel and rail wear in a rail system, comprising applying a liquid friction control composition, or a liquid and solid friction modifier composition to a rail, a wheel, or both the rail and wheel, using a consumable applicator, the consumable applicator comprising a first and a second end and a conduit within, the conduit exiting the first end, the second end for fitting with a housing, the consumable applicator comprising the solid friction control composition comprising from about 20 to about 100 weight percent resin; from 0 to about 80 weight percent lubricant; from 0 to about 40 weight percent friction modifier, and from about 0 to about 30 weight percent plasticizer, the liquid friction control composition comprising from about 40 to about 95 percent water; from about 0.5 to about 50 percent rheological agent; from about 0.5 to about 40 percent retentivity agent; from about 0 to about 40 weight percent lubricant; and from about 0 to about 25 weight percent friction modifier, whereby application of the liquid friction control composition, or the liquid and solid friction control composition reduces lateral force. The conduit within the consumable applicator may be in fluid communication with a liquid dispensing system. The liquid friction control composition, or the solid friction control composition may be selected from the group characterized as having a neutral friction characteristic (LCF), a high positive friction characteristic (HPF), and a very high positive friction characteristic (VHPF).

The present invention provides a method of reducing energy and fuel consumption in a rail system comprising applying a liquid friction control composition, or a liquid and solid friction control composition to a rail, a wheel, or both the rail and the wheel, using a consumable applicator, the consumable applicator comprising a first and a second end and a conduit within, the conduit exiting the first end, the second end for fitting with a housing, the consumable applicator comprising the solid friction control composition comprising from about 20 to about 100 weight percent resin; from 0 to about 80 weight percent lubricant; from 0 to about 40 weight percent friction modifier, and from about 0 to about 30 weight percent plasticizer, the liquid friction control composition comprising from about 40 to about 95 percent water; from about 0.5 to about 50 percent rheological agent; from about 0.5 to about 40 percent retentivity agent; from about 0 to about 40 weight percent lubricant; and from about 0 to about 25 weight percent friction modifier, whereby application of the liquid friction control composition, or the liquid and solid friction control composition reduces energy consumption. The conduit within the consumable applicator may be in fluid communication with a liquid dispensing system. The liquid friction control composition, or the solid friction control composition may be selected from the group characterized as having a neutral friction characteristic (LCF), a high positive friction characteristic (HPF), and a very high positive friction characteristic (VHPF).

The present invention also provides a combination of a consumable applicator and a liquid friction control composition, the consumable applicator comprises a first and a second end and a conduit exiting the first end, the second end for fitting with a housing, the consumable applicator comprising a friction control composition,

the friction control composition comprising from about 20 to about 100 weight percent resin; from 0 to about 80 weight percent lubricant; from 0 to about 40 weight percent friction modifier, and from about 0 to about 30 weight percent plasticizer,

the liquid friction control composition comprising from about 40 to about 95 percent water; from about 0.5 to about 50 percent rheological agent; from about 0.5 to about 40 percent retentivity agent; from about 0 to about 40 weight percent lubricant; and from about 0 to about 25 weight percent friction modifier.

The conduit within the consumable applicator may be in fluid communication with a liquid dispensing system. The conduit may be a tube within the consumable applicator. The liquid friction control composition, or the solid friction control composition may be selected from the group characterized as having a neutral friction characteristic (LCF), a high positive friction characteristic (HPF), and a very high positive friction characteristic (VHPF).

The present invention also provides an applicator for applying liquid composition comprising, an applicator housing for receiving one or more than one consumable applicator, the housing having a dispensing and a non-dispensing end the dispensing end comprising an opening through which the one or more than one consumable applicator is dispensed, the housing comprising a liquid feed and a connector for fluid communication with a conduit of the one or more than one consumable applicator when inserted within the housing, and for fluid communication with a liquid supply system, and a biasing element for advancing the consumable applicator through the dispensing end.

The consumable applicator overcomes a number of the limitations in previous systems through the use of a consumable applicator with a conduit, through which liquid, for example a lubricant or a friction control composition is dispensed directly onto one or more that one surface, and having the applicator in-contact with the one or more than one surface. As the liquid composition is not sprayed, and the applicator does not comprise a nozzle, there is no clogging or fouling of the nozzle or delivery orifice. Rather, any clogging that may occur at the opening of the conduit on the contact face of the consumable applicator is removed as the contact surface of the consumable applicator is abraded during use. Furthermore, cross current air flows have no effect on the application of a liquid composition as the applicator is in direct contact with the surface to which the composition is applied. By applying a liquid composition directly onto a steel surface the desired surface for receiving the composition is targeted, and wastage and environmental contamination is minimized. Additionally, by having the consumable applicator in fluid communication with a liquid dispensing system comprising a liquid reservoir, the duration of application of the liquid composition onto a steel surface may be increased reducing maintenance requirements to service the system.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 shows a schematic representation of an example of a consumable applicator of the present invention. FIG. 1A shows the consumable applicator within a housing and positioned against, and conformal with, a wheel surface. A fluid supply hose is also shown. FIG. 1B shows an example of a consumable applicator within a housing. and attached to a fluid supply hose. FIG. 1C shows an example of a consumable applicator, a liquid feed, biasing member and a mechanical fitting between the applicator and a liquid feed. FIG. 1D shows a non-limiting example of a consumable applicator with one conduit. FIG. 1E shows a non-limiting example of a consumable applicator with three conduits.

FIG. 2 shows a perspective view of an example of a consumable member of the present invention. The consumable applicator is within a housing, the housing is mounted to a mounting bracket, and the consumable applicator is positioned against a wheel surface.

FIG. 3 shows a plan view of an example of a consumable member of the present invention. The consumable applicator is within a housing, the housing is mounted to a mounting bracket, and the consumable applicator is positioned against a wheel surface.

FIG. 4 shows a plan view of an example of a consumable member of the present invention. The consumable applicator is located within a housing, the housing is mounted to a mounting bracket. In this example, the consumable applicator is positioned against a flange of a wheel.

FIG. 5A shows the main wheel (60) and stick mounting bracket (35) of a Stick Testing Apparatus (STA) developed to test the consumable applicator in an abrasive laboratory-controlled environment. FIG. 5B shows a schematic drawing of the STA. A doctor blade (70) that is applied to the whole width of the wheel (60), is located downstream of the housing (10) with the consumable member. A counter rotating brush (80) is applied further downstream to remove liquid friction control composition or consumable member residue or both from the wheel.

FIG. 6A shows the Flinging Time (sec) as a function of the liquid friction control composition output (ml/mile) at varying speeds. FIG. 6B show the Flinging Time (sec) as a function of the liquid friction control composition output (ml/mile) at different spring loads (3.5 lb and 2 lb) and at a speed of 10 mph. FIG. 6C shows the Flinging Time (sec) as a function of the liquid friction control composition output (ml/mile) at different spring loads (3.5 lb and 2 lb) and at a speed of 20 mph. FIG. 6D shows the Flinging Time (sec) as a function of the liquid friction control composition output (ml/mile) at different spring loads (3.5 lb and 2 lb) and at a speed of 25 mph.

### DETAILED DESCRIPTION

The present invention relates to a consumable applicator and methods for using the consumable applicator. The present invention also relates to a consumable applicator comprising friction control compositions, and methods for using the consumable applicator.

When the consumable applicator is applied under pressure against a steel surface in rolling-sliding contact with another steel surface, for example a steel rail wheel moving over a steel track, the consumable applicator wears down as it is continuously applied to the surface. The consumable applicator is consumed over an accumulated distance of travel of the wheel over the track. Once the consumable applicator is consumed it is replaced with another consumable applicator to maintain application of the composition to the steel surface.

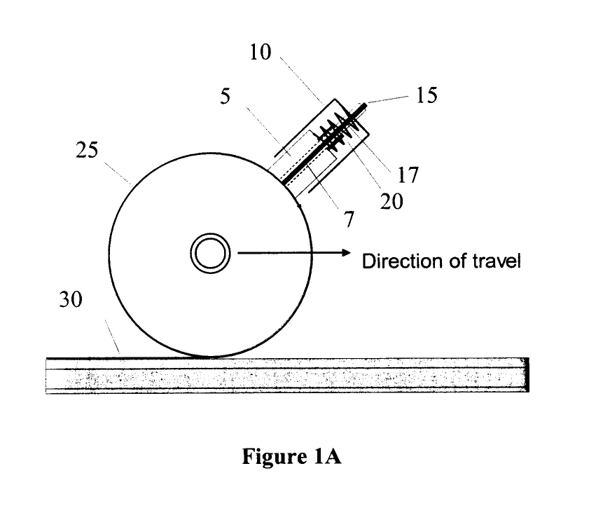

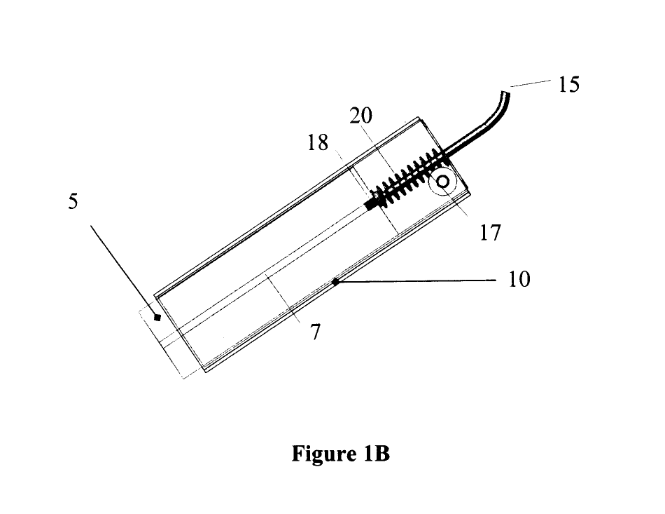

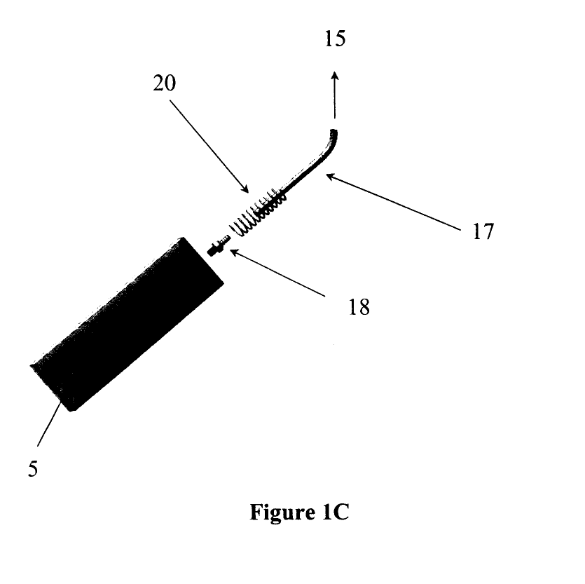

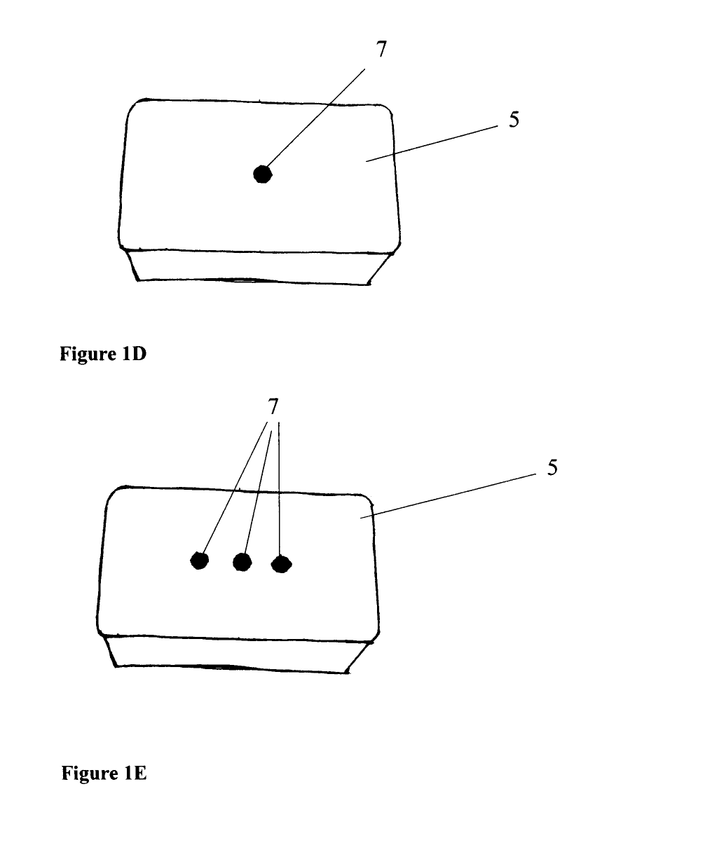

A non-limiting example of the consumable applicator is shown in FIGS. 1C and 1D. The consumable applicator (5) comprises one or more than one conduit (7) that may be connected to a liquid supply system (15; not shown) via a liquid feed or hose (17). For example the consumable applicator may comprise 1, 2, 3, 4, 5, 6, 7, 8, 9, 10 or more conduits depending upon the size of the applicator, the flow rate of the liquid on to the treated surface, the width of the application path of the liquid composition of the treated surface, or a combination thereof The conduits may vary in size as required, for example they may vary from a diameter of about 1/16″ to about ¼″ or any diameter therebetween.

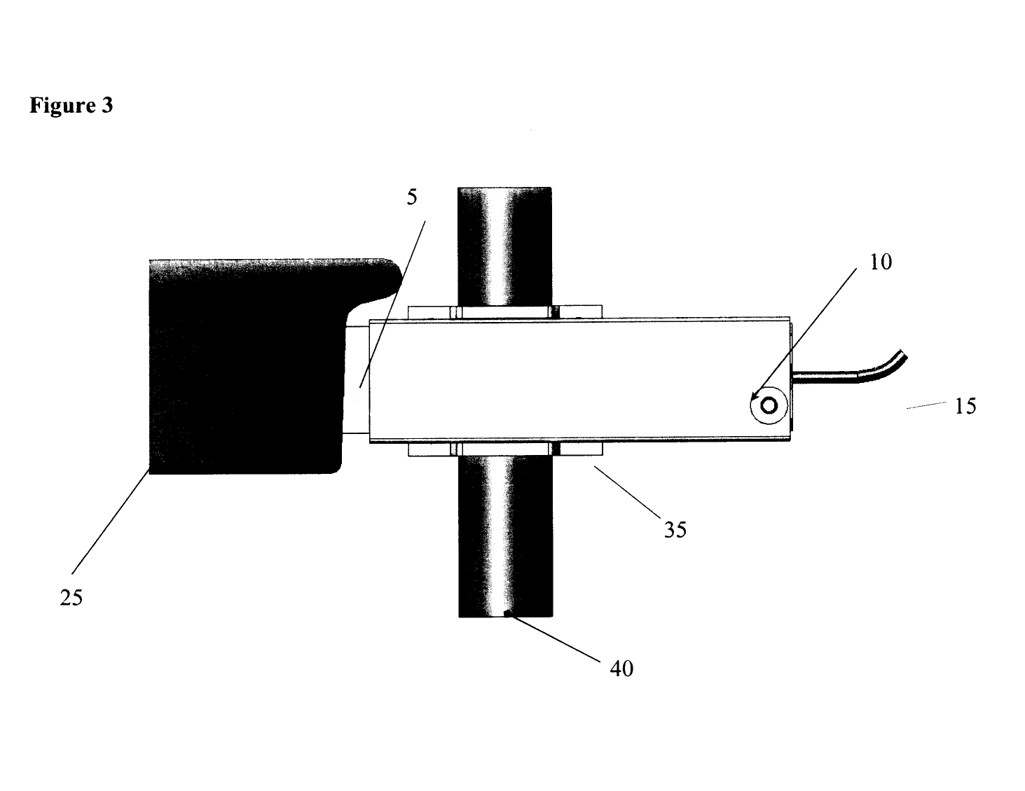

As shown in FIGS. 1A, 2, 3, 4, in use, the consumable applicator (5) is located within a housing (10; see also 1B), the housing may comprise a biasing member (20), for example a spring, that biases the consumable applicator (5) onto a surface, for example a surface of a wheel (25). One or more than one conduit (7) is present within the consumable applicator (5), and the conduit is in fluid communication with a liquid supply feed within the housing (10). The liquid supply feed (17) is in fluid communication (15) with a liquid supply system that comprising a reservoir of the liquid composition (not shown) to be applied onto the surface (25). The conduit may be mechanically attached to the supply feed using any suitable attachment or connector as known in the art, for example, the conduit may be an opening formed within the body of the consumable applicator, and the liquid supply tube may be press fit within the opening so that the surfaces of the conduit and supply feed matingly engage, or the supply feed may be attached to a lip formed at the outer surface of the body of the consumable applicator; the conduit may comprise a tube and a flexible or rigid connector may be used to ensure liquid communication from the supply feed to the tube within the conduit, or the supply feed may be directly coupled to the conduit without the use of a connector. Additional clips, clamps and fasteners may be used as required to ensure the supply feed is attached to, and in fluid communication with, the conduit. If the consumable applicator comprises more than one conduit, each conduit may extend the length of the body of the consumable applicator. This ensures that as the consumable applicator wears during use, the some number of conduit openings is present on the face of the consumable applicator.

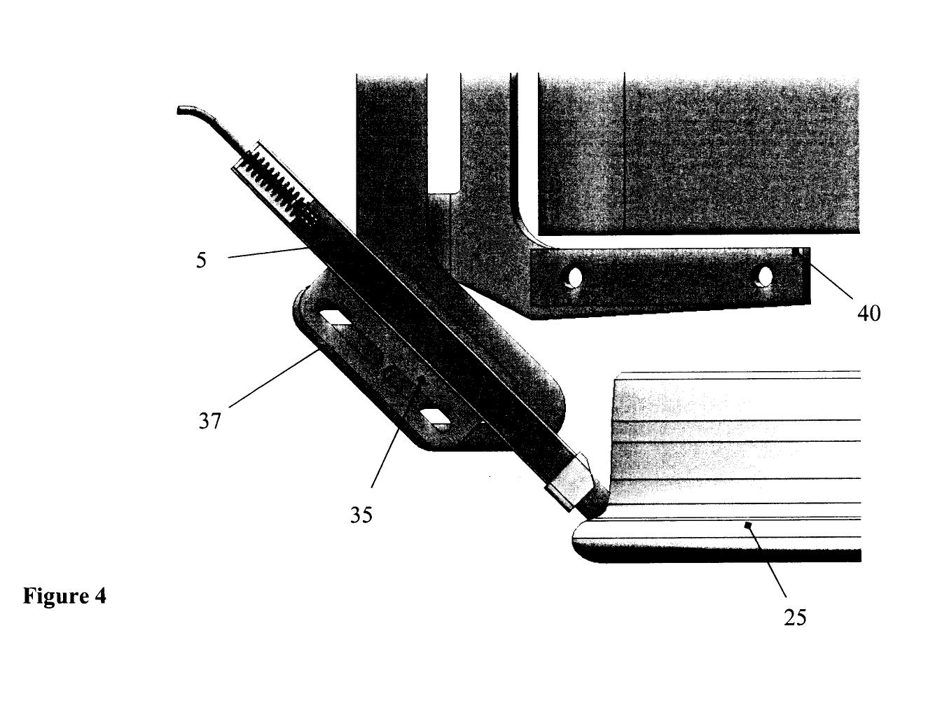

In the example shown in FIG. 1, the liquid composition is being applied onto a surface of a rail wheel (25) that is in sliding rolling contact with a rail (30). In this case the liquid composition may be a friction control composition such as a high positive friction (HPF) composition, or a very high friction control composition (VHPF; see for example as described in U.S. Pat. No. 7,045,489 (which is incorporated herein by reference). However, a liquid composition comprising a lubricant, or characterized as having a low coefficient of friction (LCF; U.S. Pat. No. 7,045,489) may be applied to a flange of a rail wheel using the consumable applicator described herein. Therefore, a lubricant composition comprising no friction modifier may be applied, and the amount applied metered based on train length, train tonnage, or both. The friction control composition may therefore be selected from the group characterized as having a neutral friction characteristic (LCF), a high positive friction characteristic (HPF), and a very high positive friction characteristic (VHPF). If the consumable applicator is directing the liquid composition to the flange surface, then the consumable applicator (5) within the housing (10) is positioned to make contact with the flange surface of the rail wheel (30) as shown in FIG. 4.

The liquid composition is supplied and metered from a dispensing system (15; not shown) in fluid communication with the consumable applicator, through a liquid supply feed (17) for example a hose or tube which may be mechanically connected (18, FIGS. 1,2) to the conduit opening so that the conduit is in fluid communication with the supply feed source, however, any connector may be used to connect the liquid supply feed to the consumable applicator. Liquid dispensing systems are known in the art, see for example U.S. Pat. No. 6,578,699, U.S. Pat. No. 2005/0285408 (which are incorporated herein by reference), however, other liquid metering and dispensing systems may also be used.

Each of the more than one conduits may be in fluid communication with the same supply feed source, or if desired, different conduits may be in fluid communication with, and supplied from different liquid supply feed sources. For example, which is not to be considered limiting, the one or more conduits, when mounted against a rail wheel, that are located adjacent to the flange surface of the rail wheel, may be in fluid communication with a supply feed that delivers a friction control composition such as a HPF or VHPF, while the composition delivered to one or more conduits located centrally on the surface of the applicator face may deliver a lubricant composition, for example an LCF composition. However, other combinations may also be delivered, for example, an LCF composition may be delivered adjacent the flange of the rail wheel, and an HPF or VHPF composition may be delivered to the conduits centrally located on the face of the consumable applicator.

The present invention therefore provides a consumable applicator having a first and a second end, one or more than one conduit within the consumable applicator exiting the first end, and the second end for fitting with a housing. The conduit may be formed within the consumable applicator, or it may be a tube that is present within an opening formed within consumable applicator. There may be more than one conduit within the consumable applicator.

The conduit within the consumable applicator may be in fluid communication with a liquid dispensing system. When the conduit is in fluid communication with the liquid dispensing system, the consumable applicator may be used to dispense a liquid friction control composition onto a metal surface that is in sliding or rolling contact with a second metal surface. The metal surface may be for example but not limited to a wheel, a flange of a wheel, a rail, an elevator rail, or a fifth wheel.

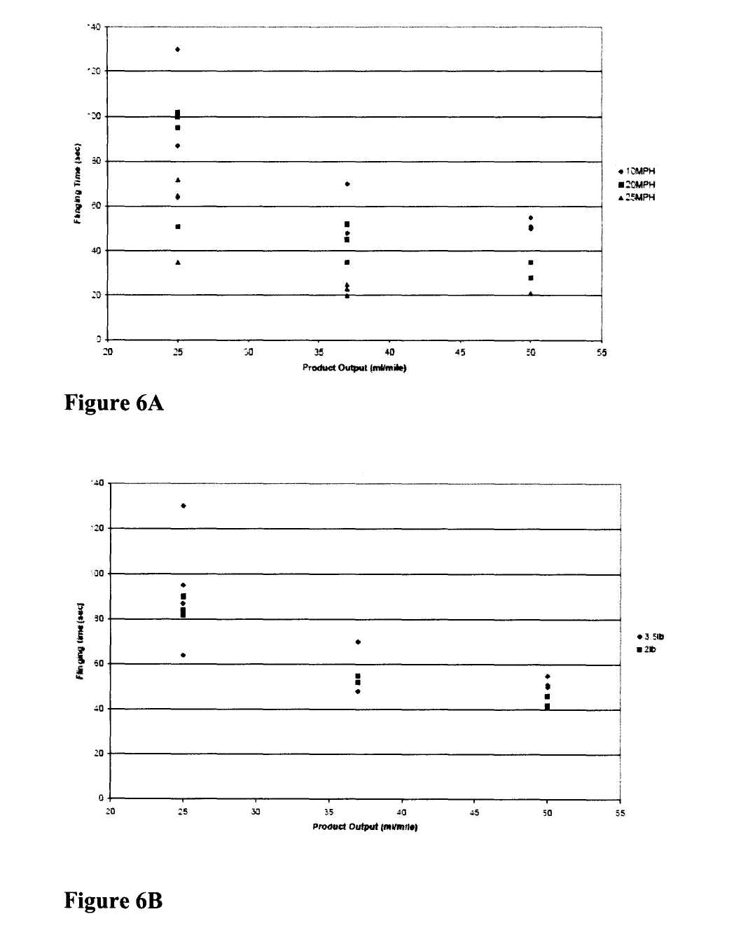

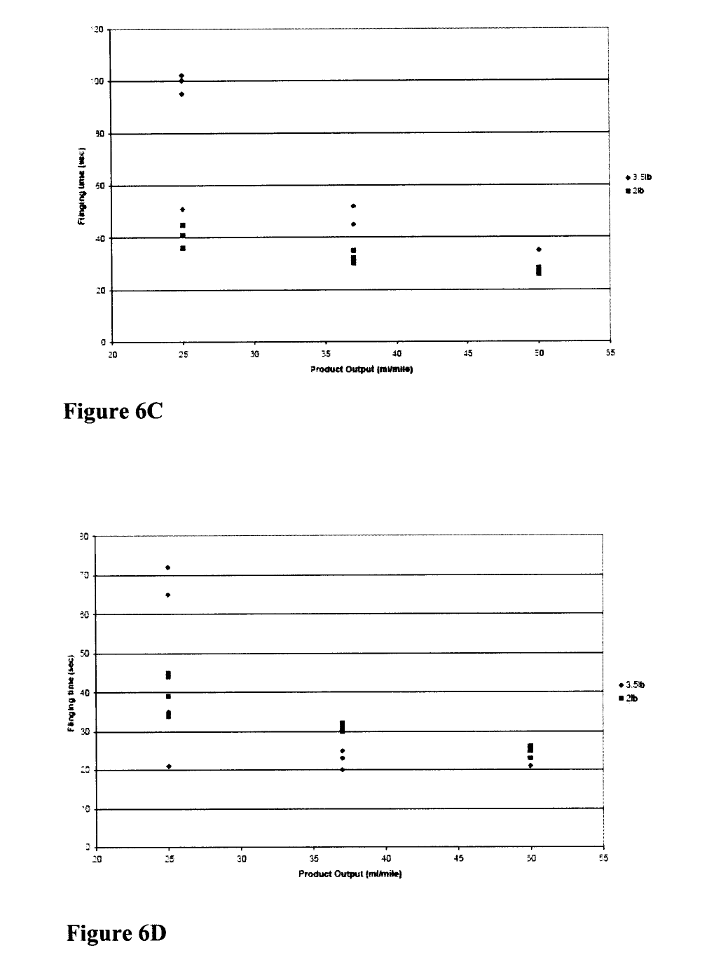

Due to the pressure exerted by the biasing element (20), the consumable applicator (5) provides a semi-sealed area against the surface (for example 25) through which the liquid lubricant or friction modifier emerges and is transferred to the metal surface. For example, spring loads from about 1.0 lb to about 5.0 lb, or any amount therebetween may be used to bias the consumable applicator against the surface. For example from about 2.0 lb to about 3.5 lb, or any amount therebetween, or about 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0 lb, or any amount therebetween. The amount of pressure used to bias the consumable applicator against the surface of the may effect the flow rate of the liquid composition onto the surface, and the amount of liquid composition that is removed (flung) from the surface as the wheel spins. As shown in FIGS. 6B and 6C, applying a lower spring force of 2 lb spring load, the liquid control composition flung off the wheel in less time when compared to the time it took the liquid composition to flung off when the applicator was pressed against the wheel with a higher force 3.5 lb. However, different amounts of liquid composition may be removed at different wheel speeds (see FIG. 6D). To counter act the removal of liquid composition at higher wheel speeds, a duty cycle may be introduced into the pump, stopping and starting the application of the liquid composition through the conduit, so that the amount of the liquid composition that is applied to the wheel surface may be reduced. Furthermore, side to side movement of a train (hunting oscillation) may cause the contact patch of the tread of wheel on the rail surface to vary. Without wishing to be bound by theory, the hunting oscillation coupled with the duty cycle of the pump may help spread the liquid control composition over the top of the rail and may minimize composition fling off.

As described herein, a composition having a Low Coefficient of Friction (LCF) can be characterized as having a coefficient of friction of less than about 0.2 when measured on a clean surface with a push tribometer or a pin on disc rheometer. Preferably, under field conditions, LCF exhibits a coefficient of friction of about 0.2 or less. A positive friction characteristic is one in which friction between the wheel and rail systems increases as the creepage of the system increases. As described herein, a composition having a High Positive Friction (HPF) can be characterized as having a coefficient of friction from about 0.28 to about 0.4 when measured with a push tribometer. Preferably, under field conditions, HPF exhibits a coefficient of friction of about 0.35. A composition having a Very High Positive Friction (VHPF) can be characterized as having a coefficient of friction from about 0.45 to about 0.55 when measured with a push tribometer. Preferably, under field conditions, VHPF exhibits a coefficient of friction of 0.5. See WO 02/026919 (which is incorporated herein by reference) for examples of LCF, HPF and VHPF compositions.

The liquid friction control composition may comprise any liquid friction control composition for example a liquid lubricant, a composition characterized as having a low coefficient of friction (LCF) when applied between two steel surfaces, a composition characterized as having a high positive coefficient of friction (HPF) when applied between two steel surfaces, or a composition characterized as having a very high positive coefficient of friction (VHPF) when applied between two steel surfaces, as described in U.S. Pat. No. 7,244,695, U.S. Pat. No. 7,045,489, U.S. Pat. No. 6,855,673, U.S. Pat. No. 6,759,372, U.S. Pat. No. 6,136,757, U.S. (all of which are incorporated herein by reference). A non-limiting example of a liquid friction control composition comprises from about 40 to about 95 percent water; from about 0.5 to about 50 percent rheological agent; from about 0.5 to about 40 percent retentivity agent; from about 0 to about 40 weight percent lubricant; and from about 0 to about 25 weight percent friction modifier. However, it is to be understood that other liquid compositions may be dispensed using the consumable applicator body as described herein, including but not limited to mineral oils, or synthetic oils, grease, and water based solutions of polymers.

If the a liquid friction control composition is an LCF composition, then it may comprise from about 40 to about 80 weight percent water; from about 0.5 to about 50 weight percent rheological control agent; from about 0.5 to about 40 weight percent retentivity agent, 0 weight percent friction modifier, and from about 1 to about 40 weight percent lubricant. If the liquid composition is an HPF composition it may comprise from about 40 to about 95 weight percent water; from about 0.5 to about 30 weight percent rheological control agent; from about 0.5 to about 25 weight percent friction modifier; from about 0.5 to about 40 weight percent retentivity agent; and from about 0.02 to about 25 weight percent lubricant. If the liquid composition is a VHPF composition, it may comprise, from about 40 to about 80 weight percent water; from about 0.5 to about 30 weight percent rheological control agent; from about 2 to about 20 weight percent friction modifier and; from about 0.5 to about 40 weight percent retentivity agent.

The consumable applicator (5) is comprised of a material that is abraded and worn away under the conditions of its use when in frictional contact against the surface to which it is applied. The material should not appreciably swell in the presence of water and the material should be thermally stable. The material that forms the consumable applicator body should also have a lower value of hardness than the metal surface with which it makes contact, so that the metal surface is not damaged upon contacting the consumable applicator body. For example, if the metal surface that is lubricated by the consumable applicator body of the present invention is the flange of a rail car wheel, then the material that forms the consumable applicator body may have a Brinnell Hardness less than about 150 BH. For example from about 25 to about 150 BH or any hardness therebetween. For example 25, 30, 40, 45, 50, 55,60, 65, 70, 75, 80, 85, 90, 95, 100, 105, 110, 115, 120, 125, 130, 135, 140, 145, 150 BH, or any amount therebetween.

The consumable applicator body can be made of a polymeric material. An example of a material that can be used in the formation of the applicator body of the present invention, includes, without limitation, a polymer, for example, polyethylene, polypropylene, high density polyethylene (HDPE), NYLON®, polybutylene terephthalate (PET), polyethylene terephthalate (PET). The consumable applicator may be comprised of a resin material, for example an epoxy resin. Alternatively, the housing may be fabricated from a fiber reinforced plastic (FRP), or a soft alloy, for example aluminum.

The consumable applicator may be comprised of a solid friction modifier or control composition. In this way two different friction control compositions may be applied to a steel surface. The solid friction control composition may comprise any solid composition, for example as described in U.S. Pat. No. 5,173,204, U.S. Pat. No. 5,308,516, U.S. publication 2007/0010405, EP 474,750, WO 2006/084386 (all of which are incorporated herein by reference), including LCF, HPF and VHPF solid compositions. A non-limiting example of a solid friction control composition comprises from about 20 to about 100 weight percent resin; from 0 to about 80 weight percent lubricant; from 0 to about 40 weight percent friction modifier, from about 0 to about 30 weight percent plasticizer, and from about 0 to about 80 weight percent vinyl ester resin. For example, if the solid composition is an LCF composition, then the composition may comprise from about 20 to about 80 weight percent lubricant; from about 20 to about 80 weight percent resin, 0 weight percent friction modifier, from about 0 to about 12 weight percent plasticizer, and from about 0 to about 80 weight percent vinyl ester resin. If the solid composition is an HPF composition, then the composition may comprise, a blend of lubricant and friction modifier, from about 20 to about 80 weight percent resin; from 1 to about 20 weight percent lubricant; from 0.5 to about 40 weight percent friction modifier, from about 0 to about 30 weight percent plasticizer, and from about 0 to about 80 weight percent vinyl ester resin. If the solid composition is a VHPF composition, then the composition may comprise from about 20 to about 80 weight percent resin; from 0.5 to about 40 weight percent friction modifier, from about 0 to about 30 weight percent plasticizer, and from about 0 to about 80 weight percent vinyl ester resin.

The consumable applicator may be comprised of two, or more than two materials, such as a first material that is resin based but may not comprise any friction modifying composition, for example an epoxy resin, and a second material comprising a solid friction control defined above, for example, either an LCF, an HPF, a VHPF composition. In this example, the resin-based portion of the consumable applicator (the first material) may be of a harder composition than the second material (the friction control composition) and assist in controlling the wear of the consumable applicator. For example, the first material may be used on the leading side of the consumable applicator and be used to clean and intercept dirt, sand, from the surface to which the liquid composition is to be applied. The second material may be of a lower harness than the first material and be applied onto the surface along with the liquid composition. An epoxy comprises a two part system of a resin and a curing agent.

The rate of wear of the consumable applicator may be varied by varying the hardness of the material or resin comprising the consumable applicator. For example, which is not to be considered limiting, the consumable applicator may wear at a consumption rate of from about 0.001 in/hour to about 0.1 in/hour or any amount therebetween. Non-limiting examples of materials of resins comprising a consumable applicator that exhibit this rate of wear range include: halogenated isophlatic polyester, isophthalic polyester, vinyl ester, epoxy vinyl ester, bisphenol epoxy vinyl ester, and halogenated bisphenol epoxy vinyl ester (as described in WO 2008/089572; which is incorporated herein by reference).

By the term ‘resin’ it is meant a chemical, compound or mixture thereof, which imparts the properties of viscosity to a composition that can be poured into preformed moulds and sets as a solid stick composition when cured. Resins include but are not limited to epoxy resin, polyurethane resin, polyurethane acrylic resin, polyester resin, thermosetting polyester resin, epoxy novolac-based vinyl ester (e.g. Derakane 470-300), brominated bisphenol-epoxy vinyl ester (e.g. DION FR 9300), vinyl polyester (e.g. DION VPE 7100-06), bisphenol-epoxy vinyl ester (e.g. DION VER 9100-00), halogenated isophthalic polyester (e.g. Heteron 99P), isophthalic polyester (DION FR 850-200), halogenated polyester (e.g. Polylite 33441-00), styrene, polystyrene, soybean-derived unsaturated polyester resin (e.g. Envirez 5000, or Envirez 1807, from Ashland), acrylated epoxidized soybean oil (AESO, e.g. Ebecryl 860, from UCB Chemicals Co., or Actilane 300 from Akzo Nobel), maleinated soybean monoglyceride (SOMG/MA), maleinated hydroxylated soybean oil (HSO/MA), corn resin, and natural fish, soybean, or tung oil in combination with other monomers for example, styrene, divinyl benzene, cyclopentadine or a combination of natural fish, soybean, or tung oil. Furthermore, resins may be combined as required and blends of these resins may be used. The use of natural oils (e.g. natural fish, soybean, or tung oil) for resin formulations may be desired for use to reduce environmental contamination or to increase utilization of renewable resources.

The amount of resin in the compositions of the present invention is from about 20 to about 80 weight percent, or any amount therebetween, for example, from about 25 to about 75 weight percent, from about 30 to about 70 weight percent, from about 35 to about 65 weight percent, from about 40 to about 60 weight percent, from about 45 to about 55 weight percent, and any amount therebetween, or about 20, 22, 24, 26, 28, 30, 32, 34, 36, 38, 40, 42, 44, 46, 48, 50, 52, 54, 56, 58, 60, 62, 64, 66, 68, 70, 72, 74, 76, 78 and 80 weight percent.

As would be known to one of skill in the art, a catalyst may be required to initiate the hardening process of a resin as described above. Examples of catalysts include, but are not limited to methylethylketone peroxide (for example but not limited to LUPEROX DDM-9™), n, n-dimethylamine, cobalt naphthenate (for example but not limited to NUXTRA COBALT 12% ™), peroxy ester (e.g. USP 245; for use with acrylated epoxidized soybean oil), or boron trifluoride diethyl etherate (BEF; for use with natural oils, for example fish, soybean, and tung oils). The use of other catalysts, or the amount of catalyst to be added can be readily determined by one of skill in the art to modify the setting rate of the resin, and should not be considered limiting to the present invention in any manner.

The consumable applicator may be of any length and of any curvature as long as the shape permits a conduit within the applicator body. For example, the consumable applicator body may be in the form of a single straight stick as described in WO 2006/116877, a single arc-shaped stick, for example as described in U.S. Pat. No. 6,854,908, or a set of straight or arc-shaped sticks having features that permit their fitting together, such as a male end and a corresponding female receiving end. If the consumable applicator comprises more than one stick, a tube may be inserted within the conduits of the consumable applicators. The tube may itself be made of a material that wears upon abrading the surface to which the consumable applicator is applied, or the tube may be part of the housing (10) and be of a length that penetrates one or more than one of the stacked consumable applicators, but that does not protrude past the surface of the housing. If the tube is not consumed during use, then it may be made of a permanent material, for example steel and the like and comprise a seal at the end of the tube that seats against the inside of the conduit of the consumable applicator. If the tube is not consumed, then the housing may comprise a mechanical connector (18) on the outer surface of the housing for connecting the tube within the housing, with the liquid supply system (15). The stick may also be molded to include a cavity in which to incorporate the tube, or the stick could be used with just the internal cavity acting as the tube.

The consumable applicator body of the present invention may be loaded into the housing of an applicator for use when being applied against a steel surface. The applicator housing may be provided with a biasing mechanism against which the consumable applicator is loaded. The biasing mechanism provides pressure against the applicator body during application so that the applicator body is available for application to a steel surface (see FIGS. 1A, 1B and 4). An alternate example of a biasing mechanism is described in WO 2006/026859.

The consumable applicator body may be loaded in any suitable applicator as long as the applicator allows adaptation to accommodate the connection of the conduit (7) to a liquid feed (17) and a liquid delivery system (15). Non-limiting examples of straight applicators include those disclosed in WO 2006/026859 (which is incorporated herein by reference), or U.S. Pat. No. 4,811,818, U.S. Pat. No. 5,054,582, U.S. Pat. No. 5,251,724, U.S. Pat. No. 5,337,860, US 2003 0101897 (which are all incorporated herein by reference). Circular applicators may also be used with the consumable applicator body of the present invention. An example of a circular applicator includes, but is not limited to that described in U.S. Pat. No. 6,854,908 (which is incorporated herein by reference).

Therefore, the present invention also provides an applicator for applying liquid composition comprising, an applicator housing for receiving one or more than one consumable applicator, the housing having a dispensing and a non-dispensing end, the dispensing end comprising an opening through which the consumable applicator is dispensed, the consumable applicator having a first and a second end and a conduit exiting the first end, the conduit in fluid communication with liquid feed, and a biasing element for advancing the consumable applicator through the dispensing end.

During use of the applicator of the present invention, the consumable applicator body is progressively consumed through frictional contact with the metal surface to which it is applied. An advantage of having the applicator be consumed during use, is that if the conduit (7) is plugged, abrasion arising from the consumable applicator against the surface will re-open the conduit within the consumable member.

The pressure provided by the biasing element provides positive seal and may be adjusted to result in a desired rate of wear of the consumable applicator. Since the primary friction control composition may be supplied as a liquid composition, then the biasing member (20) may be adjusted so as to provide a positive engagement with the surface that the composition is to be applied. For some compositions, for example an oil, a light biasing pressure may be required as the liquid composition will not tend to clog the consumable applicator. However, for viscous compositions, or film-setting compositions, such as liquid compositions that exhibit increased retentivity, a heavier biasing pressure may be desired to ensure that the conduit is cleaned during use and that no clogging occur.

By ‘theological control agent’ it is meant a compound capable of absorbing liquid, for example but not limited to water, physically swell and alter the liquid viscometric and flow properties. A rheological control agent may also function as a thickening agent, and help keep the components of the composition in a dispersed form. This agent functions to suspend active ingredients in a uniform manner in a liquid phase, and to control the flow properties and viscosity of the composition. This agent may also function by modifying the drying characteristics of a friction control composition. Furthermore, the rheological control agent may provide a continuous phase matrix capable of maintaining the solid lubricant in a discontinuous phase matrix. Rheological control agents include, but are not limited to clays such as bentonite (montmorillonite), for example but not limited to Hectabrite™, caseine, carboxymethylcellulose (CMC), carboxy-hydroxymethyl cellulose, for example but not limited to METHOCEL™ (Dow Chemical Company), ethoxymethylcellulose, chitosan, and starches.

A friction modifier is a material which imparts a positive friction characteristic to the friction control composition of the present invention, or one which enhances the positive friction characteristic of a liquid friction control composition when compared to a similar composition which lacks a friction modifier. The friction modifier preferably comprises a powderized mineral and has a particle size in the range of about 0.5 microns to about 10 microns. Further, the friction modifier may be soluble, insoluble or partially soluble in water and preferably maintains a particle size in the range of about 0.5 microns to about 10 microns after the composition is deposited on a surface and the liquid component of the composition has evaporated. Friction modifiers, described in U.S. Pat. No. 5,173,204 and WO98/13445 (which are incorporated herein by reference) may be used in the composition described herein. Friction modifiers may include, but are not limited to whiting (Calcium Carbonate), magnesium carbonate, talc (magnesium silicate), bentonite (natural clay), coal dust (ground coal), blanc fixe (calcium sulphate), asbestors (asbestine derivative of asbestos), china clay; kaolin type clay (aluminium silicate), silica—amorphous (synthetic), slate powder, diatomaceous earth, zinc stearate, aluminum stearate, magnesium carbonate, white lead (lead oxide), basic lead carbonate, zinc oxide, antimony oxide, dolomite (MgCo CaCo), calcium sulphate, barium sulphate (e.g. baryten), polyethylene fibres, aluminum Oxide, red iron oxide (Fe₂O₃), black iron oxide (Fe₃O₄), magnesium oxide, zirconium oxide, or combination thereof.

A ‘retentivity agent’ is a chemical, compound or combination of compounds that increases the effective lifetime of operation or the durability of a friction control composition between two or more surfaces in sliding-rolling contact. A retentivity agent provides, or increases film strength and adherence to a substrate. Preferably a retentivity agent is capable of associating with components of the friction composition and forming a film on the surface to which it is applied, thereby increasing the durability of the composition on the surface exposed to sliding-rolling contact. Typically, a retentivity agent exhibits the desired properties (for example, increased film strength and adherence to substrate) after the agent has coalesced or polymerized. Examples of retentivity agents, include but are not limited to, acrylics, (for example but not limited to, Rhoplex™ AC 264, Rhoplex™ MV-23L0 or Maincote HG56, Rohm & Haas); polyvinyls, polyvinyl alcohol, polyvinyl chloride or a combination thereof (for example, but not limited to, Airflex™ 728 Air Products and Chemicals; Evanol™ Dupont; Rovace™ 9100, or Rovace™ 0165, Rohm & Haas); oxazolines (for example, but not limited to, Aquazol™ 50 & 500 Polymer Chemistry); styrene butadiene compounds (for example for example but not limited to, Dow Latex 226 & 240 Dow Chemical Co.); styrene acrylate, for example but not limited to, Acronal™ S 760, BASF; Rhoplex™ E-323LO Rhoplex™ HG-74P, Rohm & Hass; Emulsion™ E-1630, E-3233, Rohm & Hass); epoxies, comprising a two part system of a resin and a curing agent. (choice of resin may depend upon the solvent used for the friction control composition for example water borne epoxies, such as, Ancares AR 550 (2,2′-[(1-methylethylidene)bis(4,1-phenyleneoxymethylene)]bisoxirane homopolymer; Air Products and Chemicals; EPOTUF™ 37-147, Bisphenol A-based epoxy; Reichhold). an amine or amide curing agents, for example, but not limited to Anquamine 419, 456 and Ancamine 1(54 (Air Products and Chemicals) may be used with aqueous epoxy formulations); hydrocarbon resins EPODIL-L (Air PRoducts Ltd.); alkyd, modified alkyds; acrylic latex; acrylic epoxy hybrid; urethane acrylic; polyurethane dispersions; various gums and resins; and a combination thereof.

By the term ‘lubricant’ it is meant a chemical, compound or mixture thereof which is capable of reducing the coefficient of friction between two surfaces in sliding or rolling-sliding contact. Lubricants include but are not limited to molybdenum disulfide, graphite, aluminum stearate, boron nitride with lamellar structure, zinc stearate and carbon compounds such as, but not limited to coal dust, carbon fibres, oil, and TEFLON™.

A grease, or a combination of greases, may be used within the compositions of the present invention. Any suitable grease may be used, including commercially available greases, vegetable-oil based greases, for example soybean, canola, sunflower, corn oils. If required a solvent may be used to reduce the viscosity of the lubricant. The grease may also comprise additives for use under extreme pressure (EP additives) for example, molybdenum disulfide, graphite and a combination thereof, and anti-oxidants. Examples of greases that may be used include, but not limited to a soy-based grease, for example, SoyTrack™ (ELM Industries; available from Portec Rail), epoxidized soybean oil (Merrol E-68), High Oleic Soybean Oil, CITIGO Summer Railroad Curve Grease No. 1, CITIGO Winter Railroad Curve Grease No.0, Marinus Rail Curve Grease, Petro Canada Rail Curve Grease, Whitmore Railmaster, Railmaster LF, Railmaster LFG, Biorail, Shell Cardura, Alvania EP D, Cyprina RA, Texaco Grease 904, Maraton Moly EP. However, it is to be understood that other grease formulations or suitable oils may also be used within the solid stick compositions as described herein. Examples of oils that may be used include hydrocarbon based oils, ester oils, vegetable-based oils (see for example U.S. Pat. No. 5,972,855) and the like. Furthermore, combinations, mixtures and blends of greases, or combinations of grease, oil, and other lubricants, for example molybdenum disulfide, graphite or a mixture thereof may also be used.

To ensure miscibility of the grease, or grease-oil mixtures with a resin, a co-solvent may be required. Examples of co-solvents include but are not limited to propylene glycol, glycol ether PnP, 4-methyl-2-pentanone, styrene, acetone, isopropyl alcohol, ethyl lactate, or ethyl lactate and methyl soyate, for example, Veritec Gold™. Co-solvents may be used at an amount from 0-25% by weight, or any amount therebetween, for example, about 2 to about 15% by weight, or any amount therebetween, or about 5-10% by weight, or any amount therebetween.

The liquid compositions of the present invention may also include other components, such as but not limited to preservatives, wetting agents, consistency modifiers, and rheological control agents, either alone or in combination. Examples of preservatives include, but are not limited to ammonia, alcohols or biocidal agents, for example but not limited to OXABAN A™. An example of a defoaming agent is Colloids 648. A wetting agent which may be included in the compositions of the present invention may include, but is not limited to, nonyl phenoxypolyol, or Co-630™ (Union Carbide).

A consistency modifier which may be included in the liquid compositions of the present invention may comprise, but are not limited to glycerine, alcohols, glycols such as propylene glycol or combinations thereof.

The solid compositions of the present invention may comprise a plasticizer at an amount that results in the solid stick composition being characterized as comprising a hardness (a property related to compression resistance, scratching resistance, and abrasion resistance) from about 40 to about 85 (determined at about 20° C.) or any amounts therebetween as measured using methods known to one of skill in the art, for example using a D-type Durometer. For example, a composition of the present invention may comprise a hardness of about 55 to about 70, or any amount therebetween, for example a hardness of 40, 53, 45, 47, 50, 53, 55, 56, 57, 58, 59, 60, 61, 62, 63, 64, 65, 66, 67, 68, 69, 70, 73, 75, 77, 80, 83 or 85, as determined at 20° C. One or more than one wax, preferably a wax that is solid at room temperature, may also be added to the solid stick compositions of the present invention to assist in modifying the hardness of the final resin.

By the term “vinyl ester resin” it is meant a resin similar in molecular structure to polyester resins, but different primarily in the location of their reactive sites. The vinyl ester molecule also features fewer ester groups when compared to polyester resins. The reactive sites of vinyl ester resins are positioned at the ends of the molecular chains. Example of vinyl ester resins include but are not limited to vinyl polyester resins, vinyl ester resins, bisphenol vinyl ester resins, epoxy vinyl ester resins, bispenol epoxy vinyl ester resins, epoxy novolac-based vinyl ester resins, and brominated bispenol epoxy vinyl ester resins. Vinyl ester resins suitable for use in the solid stick compositions of the present invention include, but are not limited to a vinyl polyester resin (for example but not limited to DION VPE 7100™), a vinyl ester resin (for example but not limited to HETRON 922™, HETRON 980™, ESTAREZ 7222PA™, and DION 9800™), a bisphenol vinyl ester (for example but not limited to DION 31038™), a bispenol epoxy vinyl ester resin (for example but not limited to SWANCOR 901™, VIPEL F010™, VIPEL FOO7™, and DION VER9100™a novolac expoxy vinyl ester resin (for example but not limited to SWANCOR 900™, SWANCOR 907™, SWANCOR 907™, VIPEL F085™, VIPEL FO86™, and DERAKANE 470-300™), a brominated bispenol epoxy vinyl ester (for example but not limited to DION FR9300^{Tm}). As would be known to one of skill in the art, a catalyst may be required to initiate the hardening process of the vinyl resin described above. Examples of catalysts include, but are not limited to, methylethylketone peroxide (for example but not limited to LUPEROX DDM-9™), cumyl hydroperoxide (for example but not limited to TRIGONOX 239A™), benzoyl peroxide, acetyl acetone peroxide, peroxy ester (for example but not limited to USP 245; for use with acrylated epoxidized soybean oil), or boron trifluoride diethyl etherare (BEF; for use with natural oils, for example fish, soybean, and Lung oils). The use of other catalysts, or the amount of catalyst to be added can be readily determined by one of skill in the art to modify the setting rate of the resin, and should not be considered limiting to the present invention in any manner.

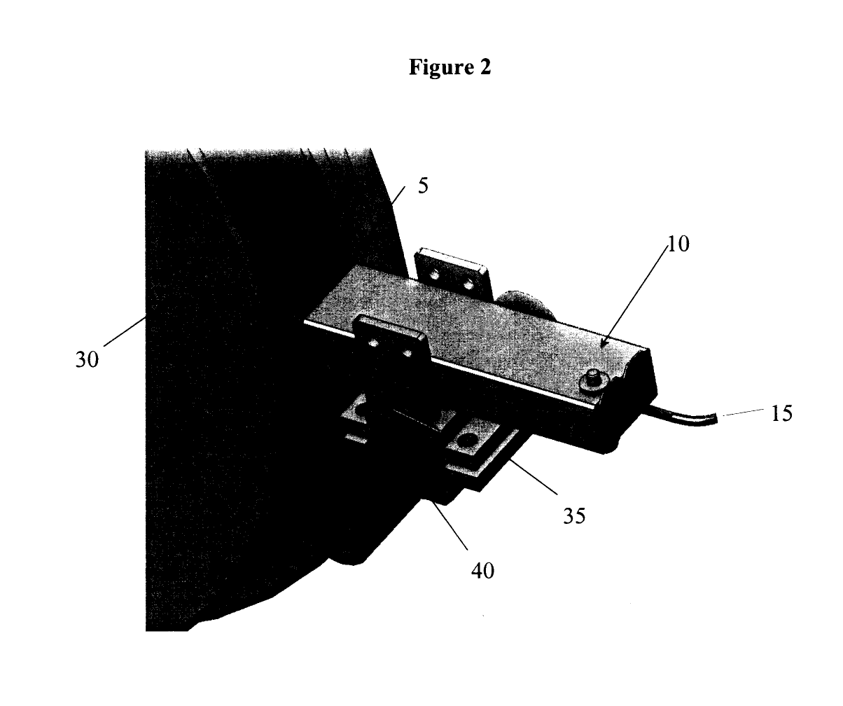

The consumable applicator body comprising a conduit has the advantage of its simplicity of mounting, operation and cleanliness which is similar to current solid stick applications, and may use existing mounting brackets (35) and be attached to existing mounting points (40; FIGS. 2 and 4). The consumable applicator body of the present invention is general resistance to fouling, plugging, drying and contamination due to a positive seal between the applicator body and the liquid film applied on the surface, and the removal of the applicator body during use. The present lubrication system with the consumable applicator body is immune to cross-wind and nozzle fouling effects that are an issue with spray based application systems. The application of liquid product include the benefit of the reduction of wear, fuel consumption, lateral forces, corrugations, fastening system degradation and noise.

The service interval of the applicator comprising consumable applicator body can be maximized via adjusting the pressure of the biasing member, changing the applicator dimension and physical properties of the consumable applicator. For example, when used under abrasive conditions, the consumable applicator may be made of a material of increased hardness so that wear is minimized.

The applicator of the present invention is useful for controlling friction between a metal surface and a second metal surface by applying a liquid or solid composition or a combination of both to a surface in steel-to-steel contact, for reducing lateral force in a rail system and for reducing energy consumption in a rail system.

The present invention will be further illustrated in the following examples.

### EXAMPLES

The following examples are intended to illustrate embodiments of the invention and should not be construed as limiting.

### Example 1

### Pump Calibration

A pump was used to deliver the liquid composition onto the test steel wheel of a stick testing apparatus (described in Example 2) at a flow rate of 0-150 ml/min. The flow rate was checked at different dial settings to determine its practical performance. The pump's performance followed the equation y=0.1332x−0.6273, where x is the dial setting and y is the flow rate in ml/min.

Typical product application rates for mobile delivery systems being used for Freight applications range between 25 and 50 ml/mile. The volumetric flow rate required is dependant on the speed of the train. Table 1, below shows required flow rates and dial settings for different speeds and output rates.

TABLE 1
Required volumetric flow rate

| Desired | | Required | | |
|---|---|---|---|---|
| Product Output | Speed | Flow Rate | Continuous | |
| (ml/mile) | (mile/hr) | ml/hour | ml/min | Dial Setting |
| 25 | 10 | 250 | 4.17 | 36 |
| 30 | 10 | 300 | 5.00 | 43 |
| 35 | 10 | 350 | 5.83 | 49 |
| 40 | 10 | 400 | 6.67 | 55 |
| 45 | 10 | 450 | 7.50 | 61 |
| 50 | 10 | 500 | 8.33 | 67 |
| 25 | 20 | 500 | 8.33 | 67 |
| 30 | 20 | 600 | 10.00 | 80 |
| 35 | 20 | 700 | 11.67 | 92 |
| 40 | 20 | 800 | 13.33 | 105 |
| 45 | 20 | 900 | 15.00 | 117 |
| 50 | 20 | 1000 | 16.67 | 130 |
| 25 | 25 | 625 | 10.42 | 83 |
| 30 | 25 | 750 | 12.50 | 98 |
| 35 | 25 | 875 | 14.58 | 114 |
| 40 | 25 | 1000 | 16.67 | 130 |
| 45 | 25 | 1125 | 18.75 | 145 |
| 50 | 25 | 1250 | 20.83 | 161 |

### Example 2

### Stick Testing Apparatus (STA Testing)

A Stick Testing Apparatus (STA) and test method as described in WO 2008/089572 (which is incorporated herein by reference), was modified, as described below, to test the consumable applicator of the present invention.

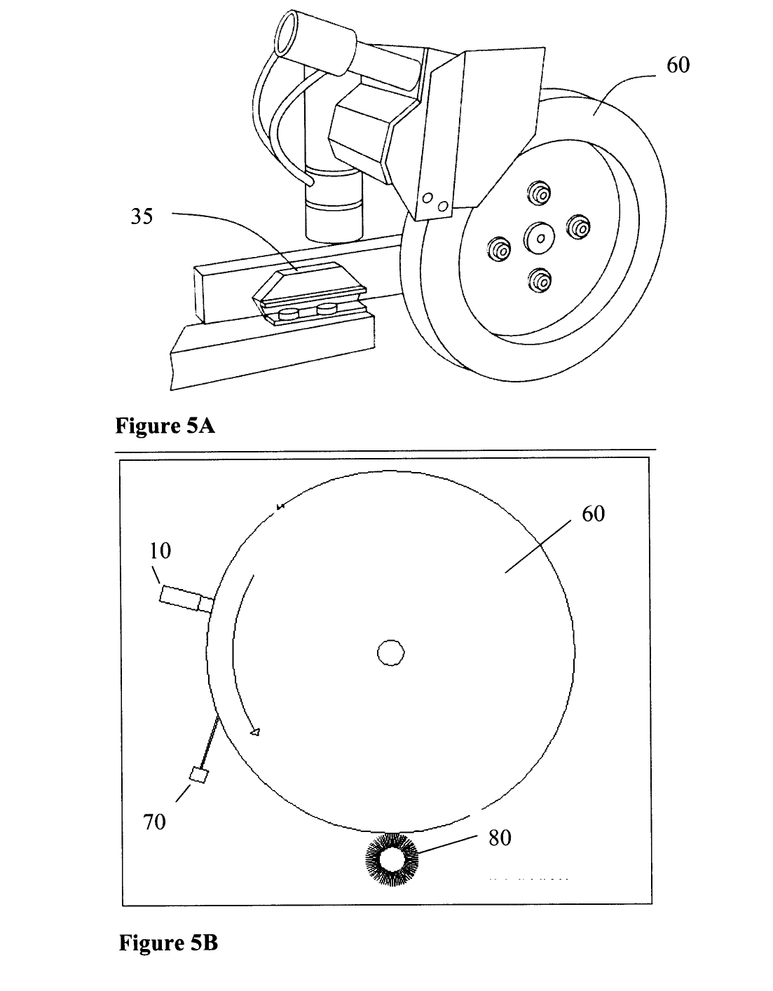

As shown in FIG. 5A, the STA comprises a frame for mounting the following components: a standard stick mounting bracket (35), which receives the consumable applicator; an abrasion resistant steel main wheel (60). As shown in FIG. 5B, the Stick Testing Apparatus further comprises a doctor blade (70) downstream of the mounting bracket and a counter rotating wire brush (80) downstream of the doctor blade.

The STA provides a rolling surface with speeds up to 60 mph (97 km/h). The diameter of the STA test wheel is 14 inches (35.56 cm) and has a surface width of 3 inches (7.62 cm).

The liquid friction control composition leaves a thin film on the surface of the wheel which transfers to the surface of the rail upon contact. To simulate transfer of the film to the rail, a doctor blade (70) is located downstream of the applicator and is applied to the whole width of the wheel. The doctor blade removes most of the liquid friction control composition on the surface of the wheel. To further remove liquid friction control composition, the counter rotating wire brush (80) is also applied to the wheel further downstream of the doctor blade.

The consumable applicator was run on the wheel until the profile of the applicator and the profile of the wheel matched in order for the consumable applicator to be sufficiently mated to the surface of the wheel and to provide a semi-sealed area against the wheel.

### Example 3

### Tests of Consumable Applicator with One Conduit

Tests were conducted with a consumable applicator comprising one conduit in the center of the applicator (see FIG. 1D). The diameter of the conduit was ⅛″ (3 mm), however conduits having other diameters may be used as required, for example from about 1/16″ to about ¼″ ar any diameter therebetween. The cross section dimensions of the applicator were 2 3/16″ (55.5 mm) by 1 3/16″ (30 mm). The applicator was made from a solid high positive friction control composition as described in U.S. Pat. No. 7,045,489 (which is incorporated herein by reference). The test showed that a thin film of liquid friction control composition is transferred to the wheel. At normal flow rates the film band spread approximately 0.5 inch (12.7 mm) across the width (tread) of the wheel.

At high flow rates (100 ml/min) and slow speeds (10 mph), the band of liquid friction control composition was 1.5″ (38.1 mm) wide.

TABLE 2
Film Band width at different flow rates

| Speed/Flow Rate | Film band width |
|---|---|
| 10 mph/25 ml/mile | 0.5 inch |
| 10 mph/596 ml/mile | 1.5 inch |

### Example 4

### Tests of Consumable Applicator with Three Conduits

Tests were conducted with a consumable applicator comprising three conduits (see FIG. 1E).). The cross section dimensions of the applicator were 2 3/16″ (55.5 mm) by 1 3/16″ (30 mm). The conduits were placed about 5/16″ (8 mm) apart from center to center of the conduits. The diameter of each conduit was ⅛″ (3 mm), however conduits having other diameters may be used as required, for example from about 1/16″ to about ¼″ ar any diameter therebetween. The applicator with three conduits produced a film band width of about 1.25 inch (32 mm) at a speed of 10 mph and flow rate of 236 ml/mile.

### Example 5

### Drying Test

The effect of leaving the consumable applicator with the liquid friction control composition unused. In one test the consumable applicator with the liquid friction control composition was left in contact with the wheel surface overnight. In a second test the consumable applicator with the liquid friction control composition was left in contact with the wheel surface for about 66 hours. No change in performance of the consumable applicator was observed.

In a second test the consumable applicator was removed from the apparatus, inverted and left overnight or for about 66 hours. Again, no change in the performance of the consumable applicator was observed.

### Example 6

### Fling Test

In the field, trains naturally experience hunting oscillations in tangent tracks, and the wheels shift laterally in curves, making it very unlikely that the contact patch will remain constant for long periods of time. To simulate the contact patch of the wheel to rail in the field, the wire brush was removed and the full width doctor blade was replaced with a 12 mm wide version. The 12 mm doctor blade was positioned at the same location as the full width doctor blade had been located.

The time it takes for the applied liquid friction control composition to fling off a rotating wheel was measure. FIG. 6A illustrates the time at which the liquid friction control composition flings off the surface of the wheel at different speeds (10 mph, 20 mph and 25 mph) and flow rates (ml/mile). The y-axis represents the minimum amount of time it took for the product to fling off the wheel while the x-axis represents the liquid friction control composition (product) output in ml/mile.

As shown in FIG. 6A the times differ substantially for the same test conditions. However, for the same given output rate at higher speeds (20 mph and 25 mph; and hence higher volumetric flow rate) the liquid friction control composition flings off the wheel in less time.

The effect of two different spring loads (3.5 lb and 2 lb) were tested. As shown in FIGS. 6B and 6C, for wheel speeds of 10 mph and 20 mph, when applying a lower force (2 lb spring load) to press the applicator against the rotating wheel, the liquid control composition flung off the wheel in less time when compared to the time it took the liquid composition to flung off when the applicator was pressed against the wheel with a higher force (3.5 lb). As shown in FIG. 6D at a wheel speed of 25 mph and with an output rate of 37 ml/mile and 50 ml/mile the liquid control composition flung off the wheel in less time when the applicator was pressed against the wheel with the higher force (3.5 lb), when compared to the applicator being pressed against the wheel with a lower force (2 lb).

To counter act this effect at higher wheel speed a duty cycle may be introduced into the pump. The hunting oscillation of a train causes the contact patch of the tread of wheel to be not constant. Without wishing to be bound by theory, the hunting oscillation coupled with the duty cycle of the pump may help spread the liquid control composition over the top of the rail as well as may minimize composition fling off.

The above description is not intended to limit the claimed invention in any manner, furthermore, the discussed combination of features might not be absolutely necessary for the inventive solution.

All citations are hereby incorporated by reference.

The present invention has been described with regard to one or more embodiments. However, it will be apparent to persons skilled in the art that a number of variations and modifications can be made without departing from the scope of the invention as defined in the claims.

What is claimed is:

1. A consumable applicator comprising a first and a second end, one or more than one conduit within the consumable applicator exiting the first end, the second end for fitting with a housing, the consumable applicator body characterized as having a Brinnell Hardness of less than about 150 BH.

2. The consumable applicator of claim 1, wherein the consumable applicator comprises a friction control composition, the friction control composition comprising from about 20 to about 100 weight percent resin; from 0 to about 80 weight percent lubricant; from 0 to about 40 weight percent friction modifier, and from about 0 to about 30 weight percent plasticizer.

3. The consumable applicator of claim 1, wherein the one or more than one conduit within the consumable applicator is in fluid communication with a liquid dispensing system.

4. The consumable applicator of claim 1, wherein the one or more than one conduit is a tube located within the consumable applicator.

5. The consumable applicator of claim 1 further comprising a housing for receiving the consumable applicator, the housing comprising a dispensing end and a second end, a biasing element for advancing the consumable applicator from the second end to the dispensing end, and a second conduit in fluid communication with a liquid dispensing system and the one or more conduit.

6. The consumable applicator of claim 1, wherein the applicator comprises three conduits.

7. A method of controlling friction between two or more than two metal surfaces in sliding rolling contact comprising, applying a liquid friction control composition, or a liquid and solid friction control composition to one of the two or more than two metal surfaces using a consumable applicator of claim 1, the consumable applicator comprising the solid composition comprising from about 20 to 100 weight percent resin; from 0 to about 80 weight percent lubricant; from 0 to about 40 weight percent friction modifier, and from about 0 to about 30 weight percent plasticizer, the liquid composition comprising from about 40 to about 95 percent water; from about 0.5 to about 50 percent rheological agent; from about 0.5 to about 40 percent retentivity agent; from about 0 to about 40 weight percent lubricant; and from about 0 to about 25 weight percent friction modifier, whereby application of the liquid friction control composition, or the liquid and solid friction control composition controls friction between the two or more than two surfaces.

8. The method of claim 7, wherein the conduit within the consumable applicator is in fluid communication with a liquid dispensing system.

9. A combination of a consumable applicator and a liquid composition, the consumable applicator comprising a first and a second end and a conduit exiting the first end, the second end for fitting with a housing, the consumable applicator comprising a solid composition, comprising from about 20 to 100 weight percent resin; from 0 to about 80 weight percent lubricant; from 0 to about 40 weight percent friction modifier, and from about 0 to about 30 weight percent plasticizer, the liquid composition comprising from about 40 to about 95 percent water; from about 0.5 to about 50 percent rheological agent; from about 0.5 to about 40 percent retentivity agent; from about 0 to about 40 weight percent lubricant; and from about 0 to about 25 weight percent friction modifier.

10. An applicator for applying liquid composition comprising, an applicator housing for receiving one or more than one consumable applicator, the housing having a dispensing and a non-dispensing end, the dispensing end comprising an opening through which the one or more than one consumable applicator is dispensed, the housing comprising a liquid feed and a connector for fluid communication with a conduit of the one or more than one consumable applicator when inserted within the housing, and for fluid communication with a liquid supply system, and a biasing element for advancing the consumable applicator through the dispensing end.
